(19) United States
(12) Patent Application Publication
(10) Pub. No.: US 2016/0121206 A1
(43) Pub. Date: May 5, 2016

(54) METHODS AND SYSTEMS FOR STORING AND PROCESSING GAME PLAY DATA FROM A GAME CONTROLLER

(71) Applicant: CINCH GAMING EQUIPMENT LLC, Ypsilanti, MI (US)

(72) Inventor: James Hackney, Ypsilanti, MI (US)

(73) Assignee: CINCH GAMING EQUIPMENT LLC, Ypsilanti, MI (US)

(21) Appl. No.: 14/831,669

(22) Filed: Aug. 20, 2015

Related U.S. Application Data
(60) Provisional application No. 62/148,638, filed on Apr. 16, 2015.
(60) Provisional application No. 62/126,132, filed on Feb. 27, 2015.
(60) Provisional application No. 62/072,691, filed on Oct. 30, 2014.

(51) Int. Cl. A63F 13/218

(52) U.S. Cl. CPC A63F 13/218

(57) ABSTRACT

Methods and systems for a game controller are provided. In one embodiment, a method includes: receiving, by a processor, a signal corresponding to an activation of one or more components of a game controller; accumulating data associated with the activation of the one or more components; and storing the accumulated data in a data storage device for further processing.

### CROSS-REFERENCE TO RELATED APPLICATION

This application claims the benefit of U.S. provisional patent application Ser. No. 62/072,691, filed Oct. 30, 2014, U.S. provisional patent application Ser. No. 62/126,132, filed Feb. 27, 2015, and U.S. provisional patent application Ser. No. 62/148,638, filed Apr. 16, 2015 which are hereby incorporated by reference in their entirety.

### TECHNICAL FIELD

The present disclosure generally relates to data resulting from play of computerized games, and more particularly to methods and systems for generating, retrieving, processing, and displaying data resulting from play of computerized games.

### BACKGROUND

Game controllers include one or more actuator devices that are depressible by an index finger or other finger of a user. During game play, a user may depress the actuator devices any number of times and in any sequence. The manipulation of the actuator devices typically causes signals to be generated. The signals are communicated to a gaming system that controls the gameplay (e.g., a game console, computer, etc.). The signals are processed by gaming software of the gaming system to determine an event or action in the game.

In some instances, it is desirable to know the number of depressions or the sequence of depressions of the actuator devices for a given game. In some instances, it is desirable to know actuation or manipulation of other components of a game controller for a given game. Systems other than the gaming system typically do not have access to this and other information resulting from gameplay. Accordingly, it is desirable to provide methods and systems for generating, retrieving, and processing game play data resulting from play of computerized games. It is further desirable to present the processed game play data to a user. Furthermore, other desirable features and characteristics of the present invention will become apparent from the subsequent detailed description and the appended claims, taken in conjunction with the accompanying drawings and this background.

### SUMMARY

Methods and systems for a game controller are provided. In one embodiment, a method includes: receiving, by a processor, a signal corresponding to a manipulation of one or more components of a game controller; accumulating data associated with the manipulation of the one or more components; and storing the accumulated data in a data storage device for further processing.

In another embodiment, a system includes memory and a processor. The processor is configured to track a manipulation of one or more components of a game controller, accumulate data associated with the manipulation of the one or more components, and store the accumulated data in the memory for further processing.

### DESCRIPTION OF THE DRAWINGS

The present disclosure will hereinafter be described in conjunction with the following drawing figures, wherein like numerals denote like elements, and:

FIG. 1 is a perspective view of a front of an exemplary game controller in accordance with various embodiments;

FIG. 2 is a perspective view of a back of the exemplary game controller of FIG. 1 in accordance with various embodiments;

FIGS. 3A and 3B are functional block diagrams illustrating exemplary computing systems of the exemplary game controller in accordance with various embodiments; and

FIG. 4 is a dataflow diagram illustrating a data manager module of the exemplary game controller in accordance with various embodiments;

FIG. 5 is a flowchart illustrating a data manager method that may be performed by the data manager module in accordance with various embodiments;

FIG. 6 is a dataflow diagram illustrating a function manager module of the exemplary game controller in accordance with various embodiments;

FIG. 7 is a flowchart illustrating a function manager method that may be performed by the function manager module in accordance with various embodiments;

FIGS. 8A, 8B, 8C, 8D, 8E, and 8F are diagrams of data processing systems including the game controller of FIG. 1 and one or more remote devices in accordance with various embodiments;

FIG. 9 is a functional block diagram of a data processing system including the exemplary game controller of FIG. 1 in accordance with various embodiments;

FIG. 10 is a dataflow diagram illustrating a program module of the remote device in accordance with various embodiments;

FIG. 11 is a dataflow diagram illustrating a program module of the remote device in accordance with various embodiments; and

FIG. 12 is a dataflow diagram illustrating a program module of the remote device in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

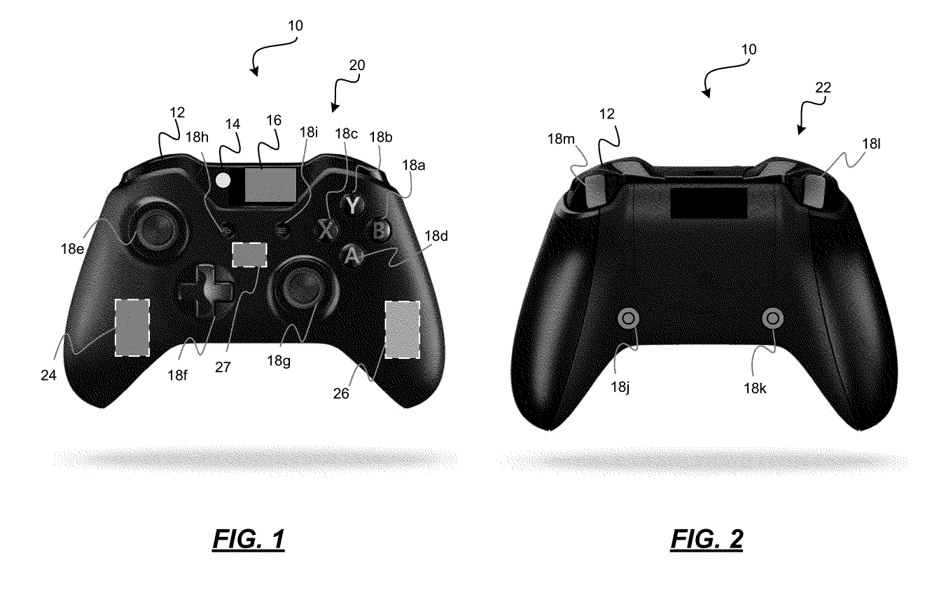

With reference to FIGS. 1-2, an exemplary game controller 10 is shown that includes one or more auxiliary modules used for generating, retrieving, processing, and displaying game play data resulting from play of computerized games in accordance with various embodiments. Although the figures shown herein depict an example with certain arrangements of elements, additional intervening elements, devices, features, or components may be present in actual embodiments. It should also be understood that FIGS. 1-2 are merely illustrative and may not be drawn to scale. The exemplary game controller 10 shown in FIGS. 1 and 2 is typically associated with a console gaming system (not shown) such as an Xbox®, PlayStation®, or Nintendo®. For exemplary purposes, the remainder of the disclosure will be discussed in the context of the exemplary game controller 10. As can be appreciated, in various embodiments, other game controllers (not shown) associated with other gaming systems (not shown), including game controllers for personal computers such as keyboards and/or a mouse, can include or can be associated with an auxiliary module as described herein.

As depicted in FIGS. 1-2, the exemplary game controller 10 generally includes a main body 12. The main body 12 may be configured to be held by a player or user of a game. The main body 12 includes one or more components (generally referred to as 13). The components 13 can include, but are not limited to, illumination devices 14, one or more display devices 16, and/or one or more actuator devices (generally referred to as 18) disposed thereon. The illumination devices 14 are controlled to emit light according to a particular color. In various embodiments, on more of the illumination devices 14 may be associated with one or more actuator devices 18 and/or one or more display devices 16 (e.g., a background light, etc.). The display device 16 is controlled to display text and/or graphics. In various embodiments, the display device 16 may be associated with an actuator device 18.

The actuator devices 18 generate signals that are transmitted (e.g., in a wired manner or wirelessly) to a gaming system (not shown) and/or processed within the game controller 10 for game play. For example, in various embodiments, a front side 20 of the game controller 10 (shown in FIG. 1) includes actuator devices 18a-18i that, when depressed or manipulated by a finger or thumb of the user, generate signals that indicate the depression of the button or a direction or degree in which the button was manipulated. For example, one or more of the actuator devices 18a-18i may be digital devices (e.g., selection buttons, direction pads, etc.) that generate digital signals based on the depression of the actuator device 18a-18i. In another example, one or more of the actuator devices 18a-18i may be analog devices (e.g., joysticks, etc.) that generate analog signals based on manipulation of the actuator device 18a-18i.

A back side 22 of the game controller 10 (shown in FIG. 2) similarly includes actuator devices 18j-18m that, when depressed or manipulated by a finger or thumb of the user, generate signals that indicate the depression of the button or a direction or degree in which the button was manipulated. For example, one or more of the actuator devices 18j-18m may be digital devices (e.g., selection buttons, or other buttons) that generate digital signals based on the depression of the actuator device 18j-18m.

In various embodiments, at least one of the actuator devices 18j-18m, such as actuator device 18l, 18m on the back side 22 of the game controller 10 is a trigger device. The trigger device includes a trigger body that is depressible. The trigger device may be an analog device that, when depressed generates an analog signal based on an amount or degree of the depression. As can be appreciated, the game controller of the present disclosure can include any number of actuator devices 18 according to any arrangement and is not limited to the present example.

In various embodiments, a configuration of one or more of the analog devices on the front side 20 of the game controller 10 and/or the back side 22 of the game controller 10 is controllable. For example, one or more of the analog devices include one or more electromechanical components (not shown) that are controlled to adjust a physical characteristic of the actuator device 18a-18m such as, but not limited to, a tension of the actuator device 18a-18m, or an electrical component of the actuator device 18a-18m such as, but not limited to, a signal value associated with a degree of manipulation.

In various embodiments, the game controller 10 may further include components 13 such as one or more haptic devices 24 (shown in phantom), one or more thermal devices 26 (shown in phantom), and/or one or more audio devices 27 (shown in phantom) that are disposed within the main body 12. The haptic devices 24 may include, for example, rumble motors and the like that are controlled to provide haptic feedback (e.g., vibration, etc.) to the user during game play. The thermal devices 26 may include, for example, a heating device or a cooling device that are controlled to provide thermal feedback (e.g., heating or cooling of the game controller 10, etc.) to the user during gameplay. The audio devices 27 may be controlled to provide audio output to a user before, during, or after game play.

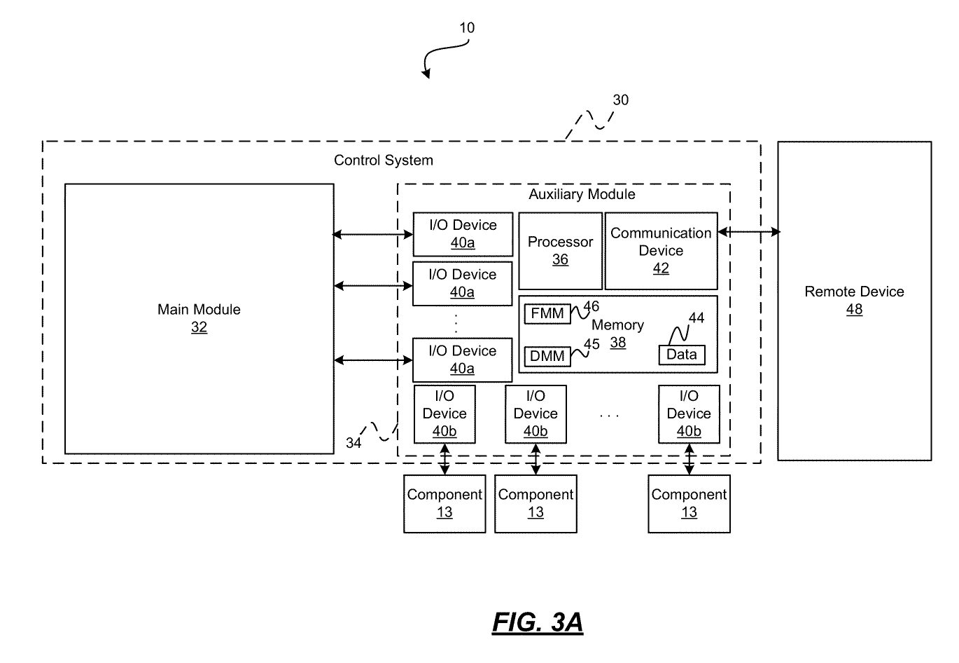

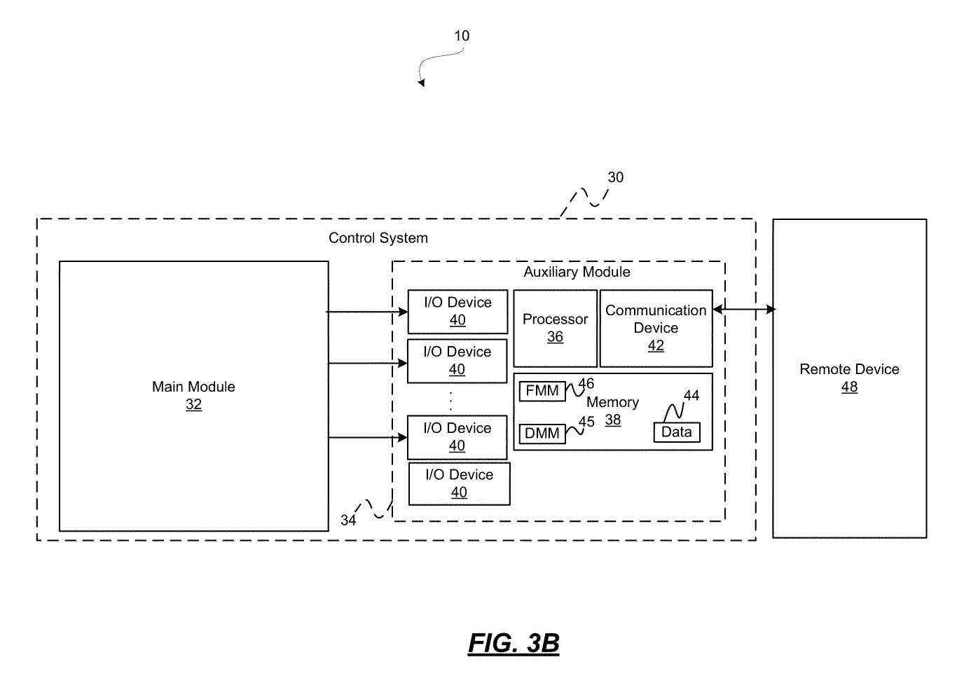

With reference now to FIGS. 3A and 3B, the game controller 10 further includes a control system 30 in accordance with various embodiments. The control system 30 includes a main module 32 and an auxiliary module 34. Although the main module 32 and the auxiliary module 34 are shown as two distinct modules, in various embodiments, all or part of the auxiliary module 34 can be implemented as a part of the main module 32 and/or all or part of the main module 32 can be implemented as a part of the auxiliary module 34.

The main module 32 is configured to operate the game controller 10 and/or to communicate with the gaming system. The main module 32 operates the game controller 10 based on default settings (e.g., settings established by a manufacturer). The default settings associate default functions and default signals with the various components 13. The main module 32 communicates information about activity of the components 13 of the game controller 10 to the gaming system. In various embodiments, the main module 32 receives information about game play from the gaming system. In response, the main module 32 controls one or more components 13 of the game controller 10. For example, the main module 32 controls the haptic devices 24, the thermal devices 26, the analog devices, the illumination devices 14, and/or the display devices 16 based on the information about game play.

In various embodiments, the auxiliary module 34 communicates with the main module 32 and/or one more of the components 13 to reconfigure one or more of the default settings or functions associated with the components 13. For example, the defaults settings or functions can be reconfigured such that a function or setting associated with a component 13 of the game controller 10 is modified from a default function or setting to a selected function or setting, such as, for example, a function or setting selected by a user. In various embodiments, the auxiliary module 34 additionally or alternatively communicates with the main module 32 and/or one or more of the components 13 to acquire data about activity of one or more of the components 13 of the game controller 10 and/or to acquire the information about game play received from the gaming system.

As shown in FIGS. 3A and 3B, the auxiliary module 34 generally includes at least one processor 36, memory 38, one or more I/O devices 40, and at least one communication device 42. As shown in FIG. 3A, the one or more I/O devices 40 include one or more I/O devices 40a that communicate with the main module 32, and one or more I/O devices 40b that communicate with the components 13. One or more of the I/O devices 40b can be configured to receive signals generated by the components 13 via one or more wired connections; and one or more of the I/O devices 40a generate signals (based on the received signals) to the main module 32 via one or more wired connections. Similarly, one or more of the I/O devices 40a can be configured to receive signals generated by the main module 32 via one or more wired connections; and one or more of the I/O devices 40b generate signals (based on the received signals) to the components 13 via one or more wired connections. Additionally or alternatively, one or more of the I/O devices 40a can be configured to receive signals indicating the information about game play.

In various embodiments, as shown in FIG. 3B, the one or more I/O devices 40 receive signals indirectly from the components 13 such as from the main module 32. For example, the auxiliary module 34 receives the signals via one or more wired connections to the main module 32. For example, the auxiliary module 34 may be implemented as a flexible circuit board or a contact style circuit board and the data may be received via wired connections (e.g., by leads, wires, etc.) to solder points on the main module 32 that connect to the components 13. Additionally or alternatively, one or more of the I/O devices 40 may receive signals indicating the information about game play. In other examples, not shown, the auxiliary module 34 receives the signals via one or more wireless connections to the main module 32 and/or to the components 13.

In general, the I/O devices 40 receive signals associated with the manipulation (e.g., either user manipulated or controller manipulated) of the components and/or associated with the information about game play. The processor 36 processes the signals received from the I/O devices 40. The processor 36 can be any custom made or commercially available processor, a central processing unit (CPU), an auxiliary processor among several processors associated with the auxiliary module, a semiconductor based microprocessor (in the form of a microchip or chip set), a macro processor, or generally any device for executing instructions. The memory 38 stores instructions that can be executed by the processor 36 and/or stores data 44 resulting from execution of the instructions. The memory 38 can include, for example, non-volatile memory, volatile memory, and/or other memory types.

The instructions stored in the memory 38 can include one or more separate programs, each of which comprises an ordered listing of executable instructions for implementing logical functions. In the examples of FIGS. 3A and 3B, the instructions stored in the memory 38 are a part of a data manager module 45 and/or a function manager module 46.

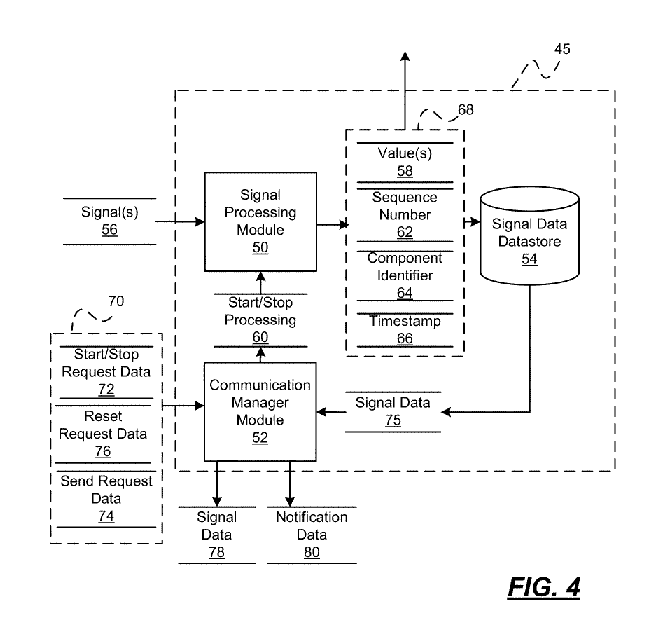

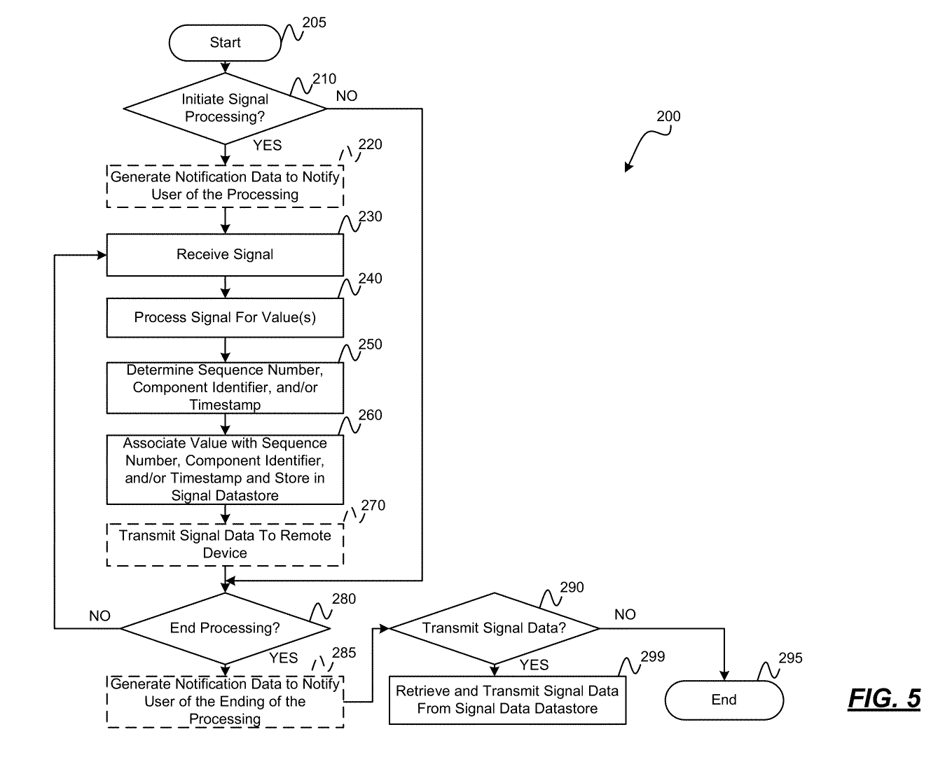

As will be discussed in more detail with regard to FIGS. 4 and 5, the data manager module 45 is configured to track and store data 44 about the manipulation of one or more of the components 13 of the game controller 10 and/or about game play in the memory 38. In various embodiments, the auxiliary module 34 communicates the stored data 44 to a remote device 48. For example, the auxiliary module 34 wirelessly (or in a wired manner) communicates the stored data 44 via a connection established through the communication device 42. The auxiliary module 34 communicates the data 44 based upon a received request and/or based upon a predetermined event (e.g., a scheduled time, an event when memory is full, etc.). The received request may be generated by the remote device 48 and received via connection established by the communication device 42. In various embodiments, the auxiliary module 34 begins and ends processing the signals from the main module 32 and/or the components 13 based on the received requests. The received requests may be generated by the remote device 48 and received via the connection established by the communication device 42. In various embodiments, the auxiliary module 34 may reset (or clear) all or part of the data 44 stored in the memory 38 based on a received request. The received request may be generated by the remote device 48 and received via the communication device 42.

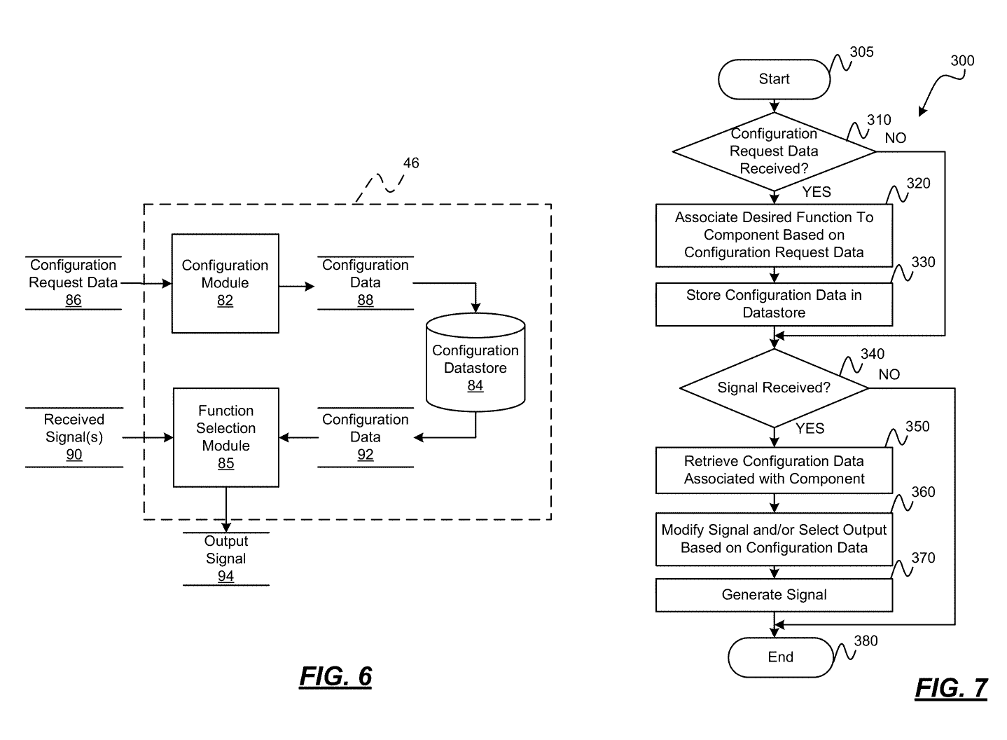

As will be discussed in more detail with regard to FIGS. 6 and 7, the function manager module 46 is configured to allow for reconfiguration of one or more of the default settings or functions associated with the components 13. In various embodiments, the auxiliary module 34 receives data wirelessly from the remote device 48 via the communication device 42. The processor 36 processes the received data in order to set a function or a setting associated with a component 13 based on the instructions of the function manager module 46.

With reference now to FIG. 4 and with continued reference to FIGS. 1-3, the data manager module 45 is illustrated in more detail in accordance with various embodiments. Various embodiments of the data manager module 45 according to the present disclosure may include any number of sub-modules. As can be appreciated, the sub-modules shown in FIG. 4 may be combined and/or further partitioned to similarly receive and process signals associated with the manipulation of the components 13 and/or indicating information about game play. The inputs to the data manager module 45 may be received from the one or more I/O devices 40, the main module 32, and/or from the one or more communication devices 42. In various embodiments, the data manager module 45 includes a signal processing module 50, a communication manager module 52, and a signal data datastore 54.

The signal processing module 50 receives as input the signals 56 generated as a result of the manipulation of the components 13 and/or as a result of the received information about game play. The signals 56 may be analog signals, digital signals, or any other type of data signal. The signal processing module 50 processes the signals 56 to determine a value or values 58 of the signal(s) 56. For example, when the signal(s) 56 is related to the manipulation of the components 13 and a digital signal, the signal processing module 50 determines the value(s) 58 to be either zero or one, indicating either activation or deactivation of the component 13. In another example, when the signal(s) 56 is related to the manipulation of the components 13 and an analog signal, the signal processing module 50 determines the value(s) 58 to be within a range of values associated with the component 13, indicating a degree of manipulation of the component 13.

The signal processing module 50 begins and stops processing of the received signals 56 based on a start/stop processing status 60 received from the communication manager module 52, based on an occurrence of an event, and/or at a scheduled time.

In various embodiments, the signal processing module 50 associates with the determined value(s) 58 a sequence number 62, a component identifier 64, and/or a timestamp 66. For example, as the signal(s) 56 is processed, the signal processing module 50 stores the value(s) 58 and the associated sequence number 62, the component identifier 64, and/or the timestamp 66 as signal data 68 in the signal data datastore 54. Optionally, the signal data 68 is transmitted to the remote device 48 after processing (e.g., in real-time).

In various embodiments, the sequence number 62 indicates an order in which the component was manipulated. The signal processing module 50 increments the sequence number 62 sequentially as the components 13 are manipulated and the signals 56 are received.

In various embodiments, the component identifier 64 indicates which component 13 is associated with the value 58. For example, each I/O device 40 is associated with a component 13; and each I/O device/component pair is associated with a unique identifier. When a signal(s) 56 is received on a particular I/O device 40, the unique identifier associated with the I/O device 40 is associated with the value(s) 58 determined from the signal(s) 56.

In various embodiments, the timestamp 66 identifies the approximate time in which the component 13 was manipulated. For example, the signal processing module 50 includes a time device that maintains the current time. The time device provides timestamps based on the current time, (e.g., upon request) when a signal(s) 56 is received. When a signal(s) 56 is received, the timestamp 66 is associated with the value(s) 58 determined from the signal(s) 56.

The communication manager module 52 receives communications from and transmits communications to the remote device 48. In various embodiments, the communication manager module 52 receives as input communication request data 70. The communication request data 70 includes, for example, start/stop request data 72, send request data 74, and/or reset request data 76. The communication manager module 52 generates the start/stop processing status 60 based on the start/stop request data 72. For example, when the start/stop request data 72 indicates start processing, the communication manager module 52 generates the start processing status 60 that is used by the signal processing module 50 to initiate processing of the signal(s) 56. In another example, when the start/stop request data 72 indicates stop processing, the communication manager module 52 generates the stop processing status 60 that is used by the signal processing module 50 to stop processing of the signal(s) 56.

The communication manager module 52 retrieves and transmits signal data 75 from the signal data datastore 54 based on the send request data 74, an occurrence of an event, and/or based on a scheduled time. For example, when the send request data 74 is received and indicates to send all or particular data, the communication manager module 52 retrieves all or the particular signal data 75 and transmits the retrieved signal data 75 as signal data 78. In another example, when the schedule time or the event occurs, the communication manager module 52 retrieves all or particular signal data 75 and transmits the retrieved signal data 75 as signal data 78.

The communication manager module 52 resets (or clears) all or particular data from the signal data datastore 54 based on the reset request data 76, an occurrence of an event, and/or based on a scheduled time. For example, when the reset request data 76 is received and indicates to reset all or the particular signal data, the communication manager module 52 resets all or the particular signal data 75 of the signal data datastore 54. In another example, when the schedule time or the event occurs, the communication manager module 52 resets all or particular signal data 77 from the signal data datastore 54. In various embodiments, the communication manager module 52 generates notification data 80 that indicates a status of the processing, a status of the storing, and/or status of the transmitting.

With reference now to FIG. 5 and with continued reference to FIGS. 1-4, a flowchart of a method 200 for processing and storing signal data associated with game play of the game controller 10 is shown in accordance with exemplary embodiments. The method 200 can be utilized in connection with the game controller 10 and the data manager module 45, in accordance with exemplary embodiments. As can be appreciated in light of the disclosure, the order of operation within the method 200 is not limited to the sequential execution as illustrated in FIG. 5, but may be performed in one or more varying orders as applicable and in accordance with the present disclosure.

As depicted in FIG. 5, the method may begin at 205. It is determined whether the signal processing has been initiated at 210 (e.g., based on received start/stop request data 72, an occurrence of an event, or a scheduled time, etc.). If the signal processing has not been initiated at 210, the method proceeds to 280.

If, however, the signal processing has been initiated at 210, optionally, notification data 80 is transmitted to the remote device 48 to indicate that processing has been initiated at 215. The signal(s) 56 is received at 230 and processed to determine the signal value(s) 58 at 240. The sequence number 62, the component identifier 64, and/or the timestamp 66 are determined at 250. The value(s) 58 is associated with the sequence number 62, the component number 64, and/or the timestamp 66 and stored as the signal data 68 in the signal data datastore 54 at 260. Optionally, at 270, the signal data 68 is transmitted to the remote device 48 (e.g., as real-time signal data).

Thereafter, it is determined whether the signal processing should be ended (e.g., based on the signal data datastore 54 being full, the start/stop request data 72 being received, an occurrence of an event, or a scheduled time, etc.) at 280. If the processing should not be stopped at 280, the method continues at 230 where a next signal(s) 56 is received.

If, however, at 260 processing should be ended, optionally, notification data 80 is transmitted to the remote device 48 to indicate that processing has been stopped and, optionally, for what reason the processing has been stopped at 285. It is then determined whether the send request data 74 is received or an event or a scheduled time has occurred to initiate transmitting the signal data 75 stored in the signal data datastore 54 at 290. If send request data 74 is not received, and the event or scheduled time has not occurred at 290, the method may end at 295. If, however, the send request data 74 is received, or the event or scheduled time has occurred at 290, the signal data 75 is retrieved from the signal data datastore 54 and transmitted to the remote device 48 as signal data 78 at 299. Thereafter, the method may end at 295.

With reference now to FIG. 6 and with continued reference to FIGS. 1-3, the function manager module 46 is illustrated in more detail in accordance with various embodiments. Various embodiments of the function manager module 46 according to the present disclosure may include any number of sub-modules. As can be appreciated, the sub-modules shown in FIG. 6 may be combined and/or further partitioned to similarly configure the settings of the components 13. The inputs to the function manager module 46 may be received from the one or more I/O devices 40, the main module 32, and/or from the one or more communication devices 42. In various embodiments, the function manager module 46 includes a configuration module 82, a configuration datastore 84, and a function selection module 85.

The configuration module 82 receives as input configuration request data 86 that may be generated by the remote device 48. The configuration request data 86 indicates a desired function and/or setting for a particular component 13. As will be discussed in more detail below, the desired function and/or setting may be selected by a user via a user interface of the remote device 48. The desired function and/or setting can include, but is not limited to, a mapping of a signal from an actuator device to an input of the main module 32, a mapping of a signal from a component 13 to a function in a game play, an activation/deactivation of an illumination device 14, an activation/deactivation of a haptic device 24, an activation/deactivation of a thermal device 26, a color or light intensity of an illumination device 14, a frequency, intensity, or duration of a haptic device 24, a temperature or duration of the thermal device 26, a tension of an actuator device, and/or a signal generated by the actuator device. The configuration module 82 stores the desired function and/or setting and the associated component as configuration data 88 in the configuration datastore 84.

The function selection module 85 receives as input signal(s) 90 from the components 13 and/or the main module 32, and stored configuration data 92. The function selection module 85 selectively controls the function and/or the settings associated with the component 13 as defined by the stored configuration data 92 by selectively receiving signal(s) 90 from and sending signal(s) 94 to one or more of the I/O devices 40 which communicate the data to and/or from the main module 32 and/or the components 13. For example, the function selection module 85 determines which I/O device 40 to route the received signal(s) 90 to and/or what signal(s) (modified or unmodified) to route to the determined I/O device 40.

With reference now to FIG. 7 and with continued reference to FIGS. 1-6, a flowchart of a method 300 for setting one or more functions and/or settings of the game controller 10 is shown in accordance with exemplary embodiments. The method 300 can be utilized in connection with the game controller 10 and the function manager module 46, in accordance with exemplary embodiments. As can be appreciated in light of the disclosure, the order of operation within the method is not limited to the sequential execution as illustrated in FIG. 7, but may be performed in one or more varying orders as applicable and in accordance with the present disclosure.

As depicted in FIG. 7, the method may begin at 305. It is determined whether configuration request data 86 is received (e.g., from the remote device 48) at 310. If configuration request data 86 is not received at 310, the method proceeds to 340. If, however, configuration request data 86 is received at 310, the desired function and/or the settings for the component is determined from the configuration request data 86 and associated at 320. The associated data is stored as configuration data 88 in the configuration datastore 84 at 330.

Thereafter, the method proceeds to determine whether a signal(s) 90 from an I/O device 40 is received at 340. If a signal(s) 90 from an I/O device 40 is received at 340, the stored configuration data 92 (default data or updated data) associated with the component 13 that generated the signal(s) 90 is retrieved from the configuration datastore 84 at 350. Optionally, the signal(s) 90 is modified (i.e. depending on the associated function) and the I/O device 40 is selected based on the stored configuration data 92 at 360. The signal 94 (modified or unmodified) is generated and transmitted by the I/O device 40 at 370. Thereafter, the method may end at 380. As can be appreciated, the method may be implemented for each component 13, for a combination of components 13, or for all of the components 13, in various embodiments.

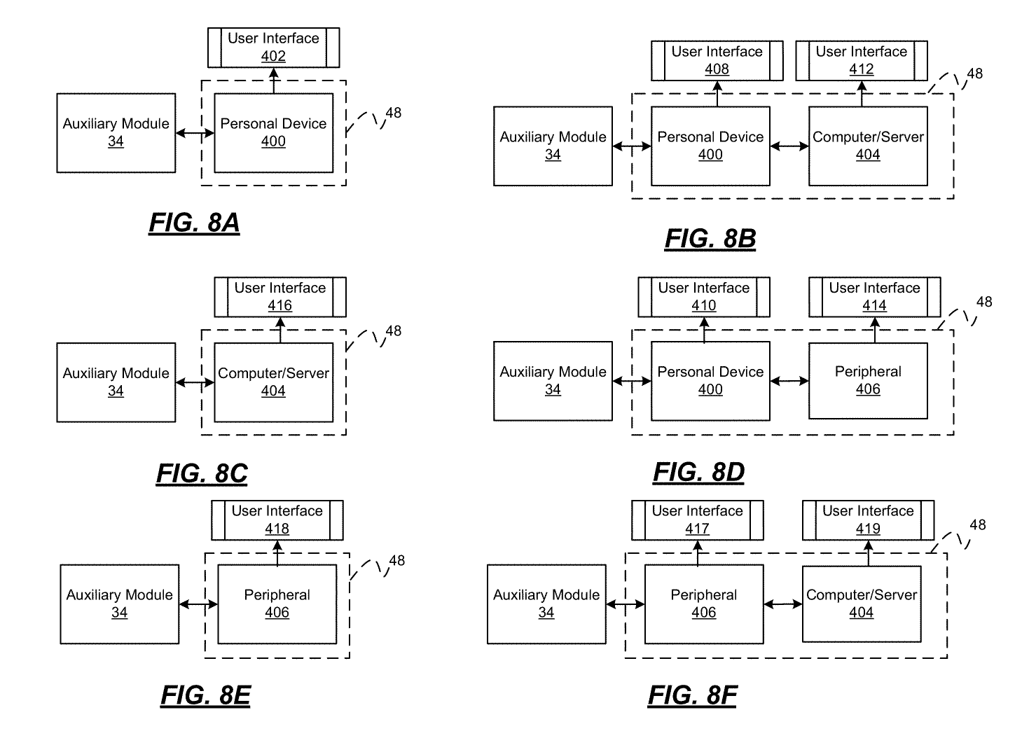

With reference now to FIGS. 8A-8F and with continued reference to FIGS. 3A and 3B, as discussed above, the auxiliary module 34 communicates with the remote device 48. The remote device 48 may be any device or combination of devices capable of communicating (in a wired manner, wirelessly, or a combination of wired and wirelessly) with the auxiliary module 34. In various embodiments, the remote device 48 is a personal device 400, as shown in FIG. 8A, such as, but not limited to, a cellular phone, a tablet, an IPod, or other device not associated with the gaming system. In such embodiments, the auxiliary module 34 communicates the data to the personal device 400, for example, via Bluetooth or other short range or long range communication protocol. The personal device 400 processes the received data and displays the processed data via a user interface 402.

As shown in FIGS. 8B, 8D, and 8F, in various embodiments, the remote device 48 includes multiple devices such as any combination of a personal device 400, a computer/server 404, and a peripheral 406. In various embodiments, the personal device 400 or the peripheral 406 may communicate the received or processed data to the other remote device 404, 406 for further processing. The personal device 400 or peripheral 406 may display the processed data via a user interface 408, 410, 417. The other remote device may then receive, optionally, further process the received data, and display the data via a user interface 412, 414, 419.

As shown in FIGS. 8C and 8E, in various other embodiments, the remote device 48 includes only a computer/server 404, or a peripheral 406. In such embodiments, the auxiliary module 34 communicates the data directly to the computer/server 404, or the peripheral 406, for example, via Bluetooth or other short range or long range communication protocol. The computer/server 404, or the peripheral 406 may then process the received data and display the processed data via a user interface 416, 418.

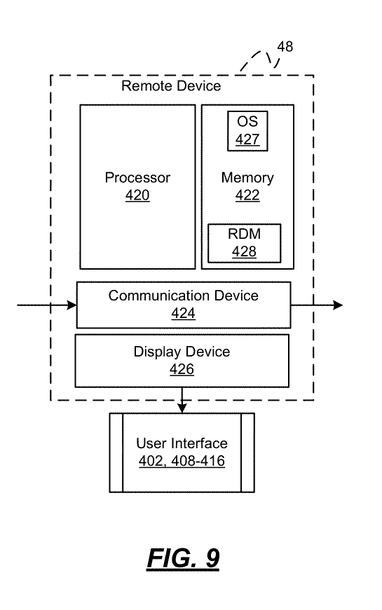

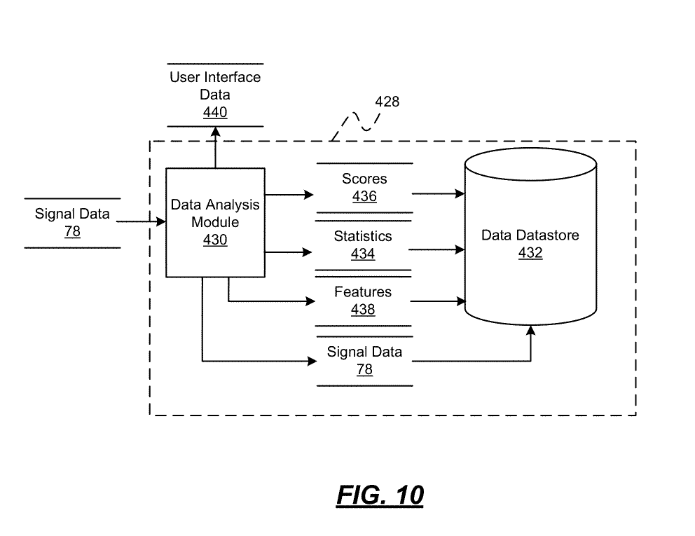

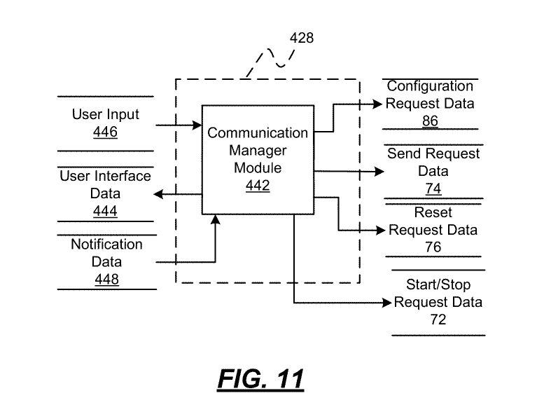

In any such embodiments, as shown in FIG. 9, the remote device 48 includes at least one processor 420, memory 422, one or more communication devices 424, and a display device 426. In general, display device 426 can be any display device capable of displaying the user interface 402, 408, 412, 416, 410, 414, 418 to the user. The communication device 424 can be any type of transceiver device that communicates data according to a wired and/or wireless communication protocol. The processor 420 can be any custom made or commercially available processor, a central processing unit (CPU), an auxiliary processor among several processors associated with the data acquisition module, a semiconductor based microprocessor (in the form of a microchip or chip set), a macro processor, or generally any device for executing instructions. The memory 422 stores instructions that can be executed by the processor 420 and/or data resulting from execution of the instructions. The memory 422 can include, for example, non-volatile memory, volatile memory, and/or other memory types. When the remote device(s) 48 is in operation, the processor 420 is configured to execute the instructions stored within the memory 422, to communicate data to and from the memory 422, and to generally control operations of the remote device 48 pursuant to the instructions.

The instructions stored in the memory 422 can include one or more separate programs, each of which comprises an ordered listing of executable instructions for implementing logical functions. In the example of FIG. 9, the instructions stored in the memory include at least a suitable operating system 427 and a program 428 for generating requests, receiving data, processing data, transmitting data, and/or displaying the data via the user interface 402, 408, 412, 416, 410, 414, 418. As can be appreciated, the functions the program 428 performs and/or the user interfaces 402, 408, 412, 416, 410, 414, 418 the program displays may depend upon the implementation of the remote device 48 as described with regard to FIGS. 8A-8E.

With reference now to FIG. 10 and with continued reference to FIGS. 1-9, in various embodiments, the program 428 includes a data analysis module 430 and a data datastore 432. The data analysis module 430 receives the signal data 78 from the auxiliary module 34 that has accumulated over time and processes the received data to determine one or more patterns. The patterns can be determined from pre-defined patterns or patterns learned over time. The patterns can correspond to actions of a game, a type of a game, an actual game being played, a game progression, etc. The identified pattern is then used by the data analysis module 430 to compute statistics 434, to compute scores 436, and/or to identify features 438 of a game or game play.

For example, based on the identified pattern, the data analysis module 430 can compute statistics for a particular gameplay, for multiple gameplays of a particular game, for multiple gameplays of a particular game or games by multiple users, etc. For example, the statistics can indicate how many times a weapon was fired (or pulled the right trigger), how many times the weapon was aimed down (or pulled the left trigger), how many jumps (or hit the A button), how many ducks (B button), etc.

Based on the computed statistics, the data analysis module 430 can determine points or a score. The points or the score can be associated with a particular user, a particular group of users, a particular game, a type of game, etc. For example, each action of a game can be assigned a point (e.g., each jump is worth say 1 point, each rapid jump (2 jumps in a row) is worth say 3 points, a jump and then a shot, could be considered a pro move that is worth say 5 points, etc.), and the points can be tallied to produce the score. The points and/or scores can be adjusted based on the timing associated with the action. A skill level can be determined from the pattern and/or the statistics. The skill level can be determined for a particular game and/or across multiple games and game types.

In various embodiments, the data analysis module 430 stores the statistics 434, scores 436, features 438, and/or the signal data 78 in the data datastore 432 for future processing. In various embodiments, the data analysis module 430 generates user interface data 440 to display the statistics 434, the scores 436, the features 438, and/or the signal data 78 in a user interface. The user interface can include graphical and/or textual elements that display the information.

With reference now to FIG. 11 and with continued reference to FIGS. 1-9, in various embodiments, the program 428 includes a communication manager module 442. The communication manager module 442 generates user interface data 444 for generating a user interface that allows a user to communicate with the auxiliary module 34. In various embodiments, the user interface can include selectable items for configuring and initiating requests. In various embodiments, the user interface can further include and/or one or more display items for displaying notifications that may be received from the auxiliary module 34. The communication manager module 442 receives user input data 446 in response to a user interacting with the user interface. The communication manager module 442 generates the configuration request data 86, the send request data 74, the reset request data 76, and/or the start/stop request data 72 in response to the user input data 446.

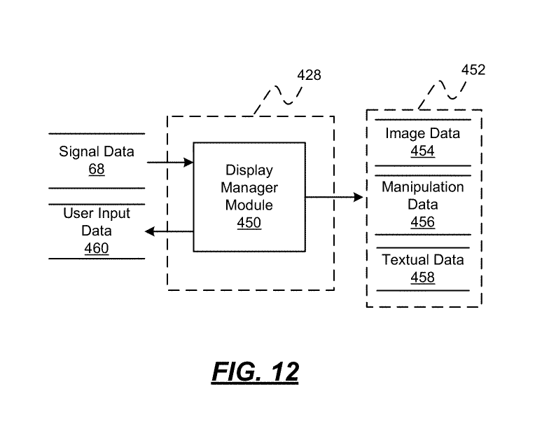

With reference now to FIG. 12 and with continued reference to FIGS. 1-9, in various embodiments the program 428 includes a display manager module 450 that manages the display of received signal data 68 via user interface data 452. For example, when the signal data 68 is transmitted in real-time, the signal data 68 can be displayed in real-time to the user. In such examples, the user interface data 452 includes, for example, image data 454 including an image representing the game controller, manipulation data 456 including effects to identified component(s) 13 that have been manipulated, and/or textual data 458 including descriptions of the manipulation (e.g., either user configured or default descriptions).

As can be appreciated, the image of the image data 454 may be any image representing the game controller 10. In various embodiments, the image may include a semi-transparent image of the game controller 10 (e.g., a wire frame image, transparent color, or other form of transparency) or displayed in a perspective such that the actuator devices on the front side and the back side of the game controller can both be seen. In various other embodiments, the image may include multiple images (e.g., one representing the back side 22 of the game controller 10 and one representing the front side 20 of the game controller 10, etc.) such that all of the components 13 can be seen. In such embodiments, the multiple images may be displayed simultaneously or may be selectively displayed one at a time based on whether a component of the front side 20 or the back side 22 has been manipulated.

The display manager module 450 processes the received signal data 68 and generates the manipulation data 456 to adjust the displayed image of the game controller 10 to identify the manipulations of the components 13. For example, the color, the size, and/or the shape of the components 13 displayed in the image may be changed, and/or the components may be highlighted to identify the manipulation. The color, the size, and/or the shape of the components 13 may be configured by a user via user input data 460 received by the display manager module 450. In various embodiments, the color, the size, and/or the shape of the component may be further changed to represent a certain type, speed, or other measurement of the manipulation. The color, the size, and/or the shape of the components 13 may be configured by a user via the user input data 460.

In various embodiments, the textual data 458 includes a text display box or simply text. The text display box or text displays a textual (and/or graphical) description of the manipulation of the components 13. The text display box can be provided in addition to the image representing the game controller 10 or as an alternative to the image. For example, the text display box can be implemented as a pop-up type box or simply text that is selectively displayed based on the manipulation.

The display manager module 450 processes the received signal data 68 and displays the images in substantially real-time as the game play. Thus, enabling a game player or other person to view the manipulations in the image as the game is being played. In various embodiments, the user interface is a sub-interface that is integrated with a user interface that displays game play. In various other embodiments, the user interface is overlaid (e.g., temporarily, permanently, or upon request) on a user interface displaying game play.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for a game controller, comprising:
receiving, by a processor, a signal corresponding to a manipulation of one or more components of a game controller;
accumulating data associated with the manipulation of the one or more components; and
storing the accumulated data in a data storage device for further processing.

2. The method of claim 1, wherein the one or more components includes at least one of an analog actuator device and a digital actuator device.

3. The method of claim 1, wherein the one or more components includes at least one of an illumination device, a haptic device, and a thermal device.

4. The method of claim 1, wherein the manipulation is by the game controller.

5. The method of claim 1, wherein the manipulation is by a user of the game controller.

6. The method of claim 1, wherein the data includes a value associated with the manipulation.

7. The method of claim 1, wherein the data includes at least one of a sequence number, a component identifier, and a timestamp.

8. The method of claim 1, wherein the tracking, the accumulating, and the storing is performed by an auxiliary module of a game controller.

9. The method of claim 9, further comprising communicating the accumulated data to a device remote from the game controller.

10. The method of claim 9, further comprising receiving a request for data from the device remote from the game controller, and wherein the communicating is based upon the request for data.

11. The method of claim 10, wherein the request is user-configured via a user interface of the device remote from the game controller.

12. The method of claim 8, further comprising receiving a request to at least one of start and stop the tracking from a device remote from the game controller, and wherein the tracking at least one of starts and stop based on the request.

13. The method of claim 12, wherein the request is user-configured via a user interface of the device remote from the game controller.

14. The method of claim 8, further comprising receiving a request to reset the accumulated data from a device that is remote from the game controller, and removing the accumulated data from the data storage device based on the request.

15. The method of claim 14, wherein the request is user-configured via a user interface of the device remote from the game controller.

16. A system for a game controller, comprising:
memory; and
a processor that is configured to track a manipulation of one or more components of a game controller, accumulate data associated with the manipulation of the one or more components, and store the accumulated data in the memory for further processing.

17. The system of claim 16, wherein the processor is further configured to receive a request from a device remote from the game controller, and wherein the tracking, the accumulating, and the storing is based on the request.

18. The system of claim 16, wherein the processor is further configured to communicate the accumulated data to a remote device.

19. The system of claim 18, wherein the processor is further configured to receive a request from the device remote from the game controller, and wherein communicating is based on the request.

20. A computer program product of a game controller, comprising:
a non-transitory computer readable medium storing instructions for performing the method of:
receiving, by a processor, a signal corresponding to a manipulation of one or more components of a game controller;
accumulating data associated with the manipulation of the one or more components; and
storing the accumulated data in a data storage device for further processing.

21-83. (canceled)
